(19) United States
(12) Patent Application Publication
(10) Pub. No.: US 2013/0051423 A1
(43) Pub. Date: Feb. 28, 2013

(54) METHOD FOR DETERMINING A TIME FOR CHARGING AN ELECTRIC ARC FURNACE WITH MATERIAL TO BE MELTED, SIGNAL PROCESSING DEVICE, MACHINE-READABLE PROGRAM CODE, STORAGE MEDIUM AND ELECTRIC ARC FURNACE

(71) Applicants: Björn Dittmer, Nurnberg (DE); Arno Döbbeler, Herzogenaurach (DE); Klaus Kruger, Hamburg (DE); Sascha Leadbetter, Munchen (DE); Thomas Matschullat, Eckental (DE); Detlef Rieger, Baldham (DE)

(72) Inventors: Björn Dittmer, Nurnberg (DE); Arno Döbbeler, Herzogenaurach (DE); Klaus Kruger, Hamburg (DE); Sascha Leadbetter, Munchen (DE); Thomas Matschullat, Eckental (DE); Detlef Rieger, Baldham (DE)

(21) Appl. No.: 13/640,211

(22) PCT Filed: Mar. 16, 2011
(86) PCT No.: PCT/EP2011/053988

§ 371 Date: Oct. 30, 2012

(30) Foreign Application Priority Data
Apr. 12, 2010 (DE) 10 2010 003 845.8

(51) Int. Cl. F27B 3/28; F27D 21/00; F27D 19/00; F27D 11/08

(52) U.S. Cl. 373/81

(57) ABSTRACT

An electric arc furnace, signal processing device, storage medium, machine-readable program code, and method for determining a time for charging (e.g., recharging) an electric arc furnace with material to be melted (e.g., scrap) are provided. The electric arc furnace may include electrode(s) for heating material inside the electric arc furnace by an electric arc. By detecting a signal for determining a phase state of an electric arc root on the side of the material to be melted based on a captured electrode current, by checking whether the signal exceeds a predetermined threshold value for a predetermined minimum duration, and by ensuring that the charging time is reached at the earliest when the signal exceeds the predetermined minimum duration threshold value, a state-oriented charging time for an electric arc furnace can be determined to reduce energy use, resource use, and production time for a production cycle to reach a tap weight.

### CROSS-REFERENCE TO RELATED APPLICATIONS

This application is a U.S. National Stage Application of International Application No. PCT/EP2011/053988 filed Mar. 16, 2011, which designates the United States of America, and claims priority to DE Patent Application No. 10 2010 003 845.8 filed Apr. 12, 2010. The contents of which are hereby incorporated by reference in their entirety.

### TECHNICAL FIELD

This disclosure relates to a method for determining a charging time for charging, especially recharging, an electric arc furnace with material to be melted, especially scrap, wherein the electric arc furnace comprises at least one electrode for heating material to be melted that is arranged inside the electric arc furnace by means of an electric arc. The disclosure further relates to a signal processing device, machine-readable program code and an electric arc furnace for carrying out the method. The disclosure further relates to a storage medium on which machine-readable program code is stored.

### BACKGROUND

In the production of steel in an electric arc furnace scrap is melted. In such cases the volume of usable material reduces during the course of the melting process by the factor of five to ten (depending on the relative density of the scrap) so that as a rule between one and two further scrap baskets have to be refilled in the electric arc furnace in order to reach a sufficient tap weight of liquid steel.

One problem is that of finding the optimum point in time for placing or refilling a further basket. This placement of a new basket is referred to as charging.

The optimum point in time for the charging is an important factor in achieving high productivity in steel manufacturing. If the furnace is charged too late, this leads to high energy losses, increased wear and lower productivity. The scrap is then completely melted and the electric arcs burn without shielding on the liquid steel bath. In addition no foam slag which could additionally shield the electric arcs occurs at this stage. On the one hand high radiation losses occur as a result since a large part of the thermal radiation turns into waste heat. This is unsatisfactory in energy terms and lengthens the power-on time unnecessarily. On the other hand the thermal radiation of the electric arc can cause slag deposits to melt onto the walls, which has an unfavorable effect on the further course of the process in relation to the energy balance a and wear on fire-proof material. Productivity falls as a result of a melting process with comparatively low efficiency. In addition, during charging, especially during the impact-type immersion of the fallen scrap into the liquid steel sump, high emissions of dust and CO (carbon monoxide) occur.

If on the other hand charging is too early, the scrap in the electric arc furnace is not yet sufficiently melted and the remaining empty volume in the oven is not large enough to accommodate the next scrap filling. This is because the process dictates that the scrap volume to be charged is introduced all at once into the vessel in one process.

In the latter case the furnace lid cannot be closed and the operator must attempt, by additionally pressing down on the pile of scrap in the vessel, to mechanically compress the scrap. Should this not be sufficient, the excess scrap must additionally be removed, to make the required closing of the furnace lid possible. This process is extremely time-consuming and thus lowers productivity to a significant extent. The tap-to-tap time increased thereby, i.e. the time between two taps, can disrupt the further sequence of the process chain in the steel works. Furthermore heat losses occur during the extra time which thus occurs, which have a further negative effect on the energy consumption and productivity.

In practice, an attempt is therefore made to melt the scrap for as long as possible in order to be certain that the scrap is melted down sufficiently and the scrap volume of the following basket can be introduced into the vessel—taking into account the disadvantages described above.

Since the furnace vessel is closed and a view through the furnace door does not allow clear information to be obtained about a complete melt, the operator only has the opportunity to some extent of determining a suitable point in time for charging the furnace.

In order to obtain optimum process management the furnace should be charged as early as possible in order to avoid unnecessary energy losses. It must therefore be ensured that the scrap in the furnace vessel is melted far enough for the next scrap basket to fit completely into the furnace vessel.

Furthermore early charging is sensible to keep the efficiency of the burners installed in the oven, which are used for additional heating of the scrap, as high as possible. If the charged scrap is immersed too greatly in the liquid steel sump when charging is too late, the melts cools down too much and a part of the pile of scrap above the melt fails to be heated up in the optimum manner by the burners.

The charging method from previous practice described above leads to increased heat losses, increased wear of the well elements or consumption of fire-proof material, higher electrode consumption, increased emissions, longer power-on and tap-to-tap time and to lower productivity.

Until now the competence and experience of the operating personnel for the arc furnace has frequently been used as a reference in order to determine a charging time. There are different indicators for the operator for reaching the charging time. For example the sound pressure level of the sound caused by the arcs falls. A further indicator is the visual impression of the progress of the melt by looking through the oven door, which has to be opened to do this.

Furthermore optical measurement methods can support the operator in the choice of charging time, for example optical sensors accommodated within a burner, cf. Nyssen, P. et al.: Innovative visualisation technique at the electric arc furnace, Revue de Metallurgie (103) 2006, No. 9, P. 369-373.

In addition to these “soft” factors, which depend to a considerable extent on the experience of the operating personnel, there are also computed factors for determining a charging time.

The practice of computing the temperature curve to be expected from a thermal model with the knowledge of the charge scrap weight, the energy introduced and other variables and of obtaining possible charging instructions from this is known, cf. Köhle, S.: Rechnereinsatz zur Steuerung von Lichtbogenöfen (Use of computers for controlling electric arc furnaces). Stahl u. Eisen (100) 1980, No. 10, P. 522-528.

Mostly these methods are employed to support the furnace operator. A few models attempt to build on this by visualizing the progress of the process for different areas of the furnace vessel, cf. Nyssen, P.; Colin, R.; Junque, J.-L.; Knoops, S.: Application of a dynamic metallurgical model to the electric arc furnace. Revue de Metallurgie (101) 2004, No. 4, 317-326. However it should be noted that this involves models without any direct measurement of the actual progress of the process.

In the simplest, by far most widely-used case charging is undertaken in accordance with a fixed drive diagram. On the basis of empirical values the time of charging is determined in this way with reference to the previously charged scrap weight and the energy applied.

Structure-borne sound measurements already performed on fully lined electric arc furnaces have not led in this context to any evaluatable result and have thus not been followed up any further, cf. Higgs, R. W.: Sonic Signature Analysis for Arc Furnace Diagnostics and Control. Proceedings IEEE Ultrasonics Symposium 1974.

The disadvantage of all these methods is that they cannot determine the charging time sufficiently accurately to charge or recharge the electric arc furnace in an efficient manner, i.e. especially at the optimum time.

### SUMMARY

In one embodiment, a method is provided for determining a charging time for charging, especially recharging an electric arc furnace with material to be melted, especially scrap, wherein the electric arc furnace has at least one electrode for heating material to be melted that is arranged within the electric arc furnace by means of an electric arc, wherein a first signal, for determining a phase state of a arc root point on the side of the material to be melted is established on the basis of a detected electrode current, that a check is made as to whether a first signal exceeds a predetermined threshold value for a predetermined minimum duration, that the charging time is reached at the earliest when the first signal exceeds the threshold value for the predetermined minimum duration.

In a further embodiment, an S function is used to establish the first signal. In a further embodiment, to establish the first signal for the S function, a ratio of electrode current contributions for a whole-number multiple of double the mains operating frequency and electrode current contributions is included, which are present between whole-number multiples of double the mains operating frequency.

In another embodiment, a method is provided for determining a charging time for charging, especially recharging, an electric arc furnace with material to be melted, especially scrap, wherein the electric arc furnace has at least one electrode for heating material to be melted that is arranged within the electric arc furnace by means of an electric arc, wherein a second signal, for defining a part of the solid-type material to be melted adhering to a delimitation, especially furnace wall, of the electric arc furnace is determined with detected structure-borne sound waves, wherein a check is made as to whether the second signal exceeds a predetermined threshold value for a predetermined minimum duration, wherein the charging time is reached at the earliest when the second signal exceeds the threshold value for the predetermined minimum duration.

In a further embodiment, to establish the second signal, a signal-to-noise ratio from structure-borne sound signal components of discrete frequencies and from structure-borne sound signal components for frequencies deviating in a predetermined interval from discrete frequencies is formed. In a further embodiment, to establish the second signal, an electrode current signal component at a mains operating frequency of the electric arc furnace, especially 50 Hz or 60 Hz, is included. In a further embodiment, the second signal is established by means of the equation:

SKs=c*(SNR−d)*(GG−0.9),

wherein

SNR: is the signal-to-noise ratio,

GG: is the electrode current component at the mains operating frequency

c: is a gain factor and

d: is an offset value.

In another embodiment, a method is provided for determining a charging time for charging, especially recharging, an electric arc furnace with material to be melted, especially scrap, wherein the electric arc furnace has at least one electrode for heating material to be melted that is arranged within the electric arc furnace by means of an electric arc, wherein a first signal for determining a phase state of an electric arc root point is established on the basis of a detected electrode current, wherein a second signal, for determining a solid-type part of the material to be melted adhering to a delimitation, especially furnace wall, of the electric arc furnace is established by means of detected structure-borne sound waves, wherein the charging time is established using the first and the second signal.

In a further embodiment, an average signal is established from the first signal and the second signal, wherein a check is made as to whether the average signal exceeds a predetermined threshold value for a predetermined minimum duration, wherein the charging time is then reached at the earliest when the average signal lies above the threshold value for a predetermined minimum duration. In a further embodiment, a check is made as to whether the first signal exceeds a predetermined threshold value for a predetermined minimum duration, wherein a check is made as to whether the second signal exceeds a predetermined threshold value for a predetermined minimum duration, wherein the charging time is then reached at the earliest when the first and the second signal simultaneously each lie above the respective associated threshold value for a predetermined minimum duration. In a further embodiment, the electric arc furnace comprises more than one electrode, especially three electrodes, and/or more than one structure-borne sound sensor, especially three structure-borne sound sensors, wherein the charging time is determined in accordance with one of the preceding claims, taking into account the detected electrode currents of all electrodes and/or taking into account the detected structure-borne sound vibrations of all structure-borne sound sensors.

In another embodiment, a signal processing device for an electric arc furnace includes machine-readable program code comprising control commands which cause the signal processing device to carry out any of the methods disclosed above.

In another embodiment, machine-readable program code for a signal processing device for an electric arc furnace comprises control commands which cause the signal processing device to carry out any of the methods disclosed above. In another embodiment, a storage medium storing such machine-readable program code is provided.

In another embodiment, an electric arc furnace is provided with a least one electrode, with an electrode current detection device for detecting an electrode current of the at least one electrode, with a least one structure-borne sound sensor for detecting structure-borne sound vibrations of a delimitation, especially of the furnace wall, of the electric arc furnace, and with a signal processing device as disclosed above, wherein the electrode current detection device and the structure-borne sound sensors are actively connected to the signal processing device.

In a further embodiment, the signal processing device is actively connected to an open-loop and/or closed-loop control device which is actively connected to a charging device, and the charging of material to be melted is able to be controlled and/or regulated by the open-loop and/or closed-loop control device.

### BRIEF DESCRIPTION OF THE DRAWINGS

Example embodiments will be explained in more detail below with reference to figures, in which:

FIG. 1 shows a schematic diagram of an electric arc furnace,

FIG. 2 shows a flow diagram for a method for determining the charging time using electrode currents,

FIG. 3 shows a flow diagram for a method for determining the charging time using structure-borne sound waves, and

FIG. 4 shows a flow diagram for a method for determining the charging time using electrode currents and using structure-borne sound signals.

### DETAILED DESCRIPTION

Some embodiment are configured to determine a state-oriented charging time for the operation of an electric arc furnace and to provide corresponding facilities to reduce use of energy, use of resources and production time for a production cycle to achieve a tap weight.

For example, some embodiments provide a method for determining a charging time for charging, especially recharging, material to be melted, especially scrap in an electric arc furnace, wherein the electric arc furnace has at least one electrode for heating material to be melted that is arranged within the electric arc furnace by means of an electric arc, wherein a first signal is determined for defining a phase state of an electric arc root on the side of the material to be melted on the basis of a captured electrode current, wherein a check is made as to whether the first signal exceeds a predetermined threshold value for a predetermined minimum duration, wherein the time for charging is then reached at the earliest when the first signal exceeds the threshold value for the predetermined minimum duration.

The fact that this method is based on a current state in the electric arc furnace means that this offers enormous advantages compared to the methods for determining charging times in accordance with conventional techniques. Charging is always undertaken at the optimum possible time, i.e. additional power-on times are avoided. On the other hand further charging is late enough for it to be ensured that the charged material for melting can be introduced completely into the electric arc furnace, through which the production times for a melt are kept as low as possible.

Material to be melted is understood as solid or liquid metal which is intended for the production of the metal bath, especially steel bath. Frequently the material to be melted with which the electric arc furnace is to be charged is scrap.

The use of the term first signal and second signal, see information given below, merely serves to distinguish between the signals for the reader. There is no further relevance attached to the term “first” or “second”.

In an advantageous embodiment an S function is used for determining the first signal. This is also known under the name logistics function. It has been shown that using the S function delivers especially good results.

It is also of advantage, for determining the first signal, to include a ratio of electrode current contributions at a whole-number multiple of double a mains operating frequency and to include electrode current contributions which are present between whole number multiples of double the mains operating frequency. The mains operating frequency is the frequency with which a mains supply supplies the electric arc furnace. The electrode current contributions may be determined on the basis of the squared electrode current signal, since these are a better measure for the performance and react more sensitively for the intended purpose.

Further information for determining the first signal can be found in the description of the figures.

Other embodiments provide a method for determining a charging time for charging, especially recharging an electric arc furnace with material to be melted, especially scrap, wherein the electric arc furnace has at least one electrode for heating material to be melted that is arranged within the electric arc furnace by means of an electric arc, wherein a second signal for determining a solid-type part of the material to be melted adhering to a delimitation, especially a furnace wall, of the electric arc furnace is determined by means of captured structure-borne sound waves, wherein a check is made as to whether the second signal exceeds a predetermined threshold value for a predetermined minimum duration, wherein the charging time is then reached at the earliest when the second signal exceeds the threshold value for the predetermined minimum duration.

The second signal may be determined by forming a signal-to-noise ratio from body-borne signal components of discrete frequencies and from body-borne signal components for frequencies deviating from the respective discrete frequency in a predetermined interval.

Furthermore the determination of the second signal may be additionally based on an electrode current signal component at a mains operating frequency of the electric arc furnace, especially 50 Hz or 60 Hz.

This may be used to determine the second signal on the basis of the equation:

SK=c*(SNR−d)*(GG−0,9),

wherein

SNR: is the signal-to-noise ratio,

GG: is the electrode current signal component at the mains operating frequency

c: is a gain factor, and

d: is an offset value.

The gain factor c may be selected so that the signal goes towards one, as soon as the flat bath phase is reached.

Other embodiments provide a method for determining a charging time for charging, especially recharging and electric arc furnace with material to be melted, especially scrap, whereby the electric arc furnace has at least one electrode for heating material to be melted that is arranged within the electric arc furnace by means of an electric arc, wherein a first signal is determined for defining a phase state of an electric arc root on the side of the material to be melted on the basis of a captured electrode current, wherein a second signal for determining a solid-type part of the material to be melted adhering to a delimitation, especially a furnace wall, of the electric arc furnace is determined by means of captured structure-borne sound waves, wherein the charging time is determined using the first and the second signal.

Through the combined use of the first and the second signal, the likelihood of determining an optimum charging time for the process can be further increased.

In one embodiment the first signal and the second signal are averaged, in which case a check is made as to whether the average signal falls below a predeterminable threshold value for a predetermined minimum duration, wherein the charging time is then reached at the earliest when the average signal lies above the threshold for a predetermined minimum duration.

The determination of an averaged signal from the first and the second signal represents a simple and practicable combination of the signals. Known methods, such as arithmetical averaging or geometrical averaging can be employed for averaging.

As an alternative the process used can advantageously be that of checking whether the first signal exceeds a predetermined threshold value for a predetermined minimum duration, checking whether the second signal exceeds a predetermined threshold value for a predetermined minimum duration, wherein the charging time is then reached at the earliest when the first and the second signal each simultaneously lie for a predetermined minimum duration above the respective associated threshold value.

The coupled observation of the first and second signals in respect of the fulfillment of the respective test criteria is likewise a method that functions well for safely determining a charging time optimized as much as possible to the process.

In one embodiment the electric arc furnace comprises more than one electrode, especially three electrodes and/or more than one structure-borne sound sensor, especially three structure-borne sound sensors, wherein the charging time is determined in accordance with one of claims 1 to 10, taking into account the captured electrode currents of all electrodes and/or taking into account the captured structure-borne sound vibrations of all structure-borne sound sensors.

By taking into account the electrode currents of all electrodes included in the electric arc furnace and/or of the signals of all structure-borne sound sensors included in the electric arc furnace, it is ensured that a charging time is only seen as available when the desired state in the electric arc furnace is also reached. Through this it is ensured that an uneven melting of the scrap for the electrodes does not lead to a premature charging time, so that the scrap to be recharged might not fit into the furnace.

Common to all the methods described above is that for determining a charging time optimized to the process for an ongoing electric arc furnace process, there is recourse to captured data from this electric arc furnace process currently running. This means that it is possible for the state of the material to be melted in the electric arc furnace to be verified online and accordingly a charging time dependent on this state of the material to be melted in the electric arc furnace is able to be established. By the use of signals which correlate with the state of the material to be melted, the progress of the process can thus be followed relatively precisely in real time, which makes it possible to determine a charging time that is optimized as much as possible to the process.

The object is also achieved by a signal processing device for an electric arc furnace with machine-readable program code comprising control commands which cause the signal processing device to carry out a method according to one of claims 1 to 11.

The object is further achieved by machine-readable program code for a signal processing device for an electric arc furnace, wherein the program code comprises control commands which cause the signal processing device to carry out the method according to one of claims 1 to 11.

Additionally embodiments of the invention also extend to a storage medium with machine-readable program code stored thereon in accordance with claim 13.

As regards the apparatus, the object is achieved by an electric arc furnace with at least one electrode, with an electrode current detection device for detecting an electrode current supplied to the at least one electrode, with at least one structure-borne sound sensor for capturing structure-borne sound vibrations of a delimitation of the electric arc furnace and with a signal processing device according to claim 12, wherein the electrode current detection device and the structure-borne sound sensors are actively connected to the signal processing device.

An electric arc furnace embodied in this way can be operated with the disclosed method, through which various advantages can be realized.

The signal processing device may additionally be connected to an open-loop and/or closed-loop control device which is actively connected to a charging device, wherein the charging of material to be melted is able to be controlled and/or regulated by means of the open-loop and/or closed-loop control device. This makes full automation possible. This is not mandatory however. The charging time determined can also be notified, e.g. displayed, to the operating personnel, so that they initiate the charging manually. The signal processing device can be identical in its construction to the open-loop and/or closed-loop control device. As an alternative these can also be embodied as different, spatially separated units.

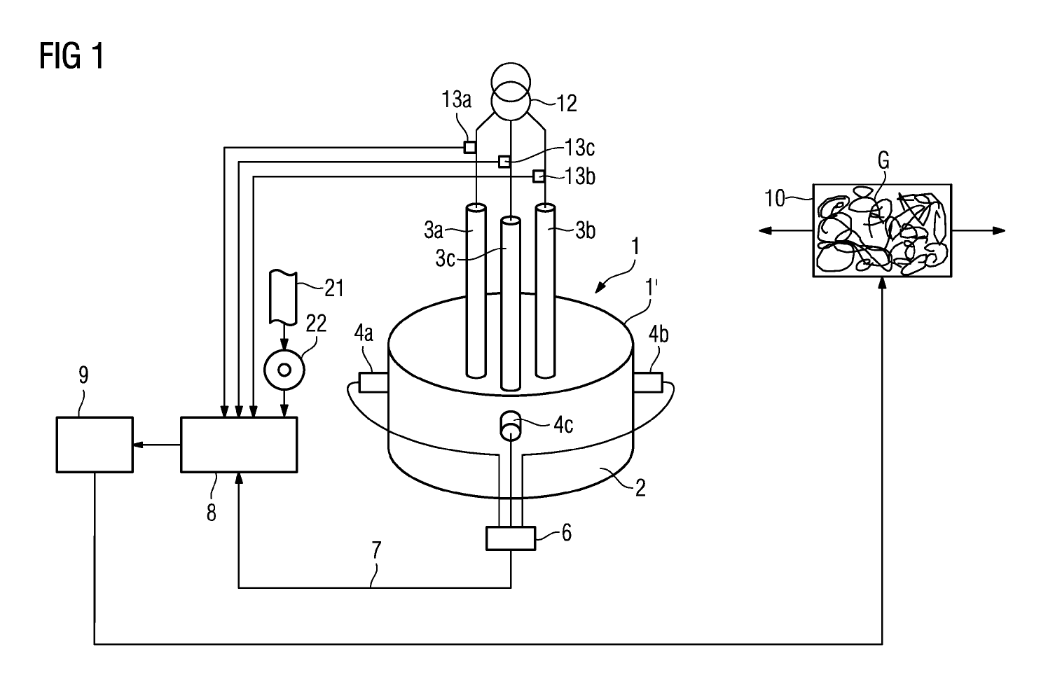

FIG. 1 shows a schematic diagram of an electric arc furnace 1, especially an alternating current electric arc furnace. In the production of metal melts, especially steel baths, it is necessary to charge the electric arc furnace 1 with material G to be melted several times, especially to charge a furnace vessel 1′ encompassed by the electric arc furnace, in order to achieve a desired tap weight for the liquid metal present in the furnace at the end of the melting process. It is frequently the case that the electric arc furnace 1 is refilled with scrap twice for this purpose. However more or fewer than two refillings can also be necessary. This depends inter alia on the electric arc furnace 1 and its capacity.

For three necessary scrap charges to reach the tap weight the melting process thus starts initially with a first loading or a first charge of scrap.

This will be very largely or entirely melted. Then the second charge of scrap is introduced into the furnace 1 and melted. Subsequently the third loading of scrap is introduced into the furnace. This too is melted and the liquid metal bath is prepared for tapping.

For recharging, i.e. for the above second and third scrap loading, it is necessary to bring the electrodes 3a, 3b, 3c out of the electric arc furnace 1. As a rule the lid of the furnace 1 is also opened for this purpose. Thus the electrodes 3a, 3b, 3c are mounted to be at least height-adjustable and frequently also pivotable.

In the present case the electric arc furnace 1 comprises three electrodes 3a, 3b, 3c. The electrode currents of the respective electrodes 3a, 3b, 3c are each captured with a corresponding capture device 13a, 13b or 13c. The electrodes 3a, 3b, 3c are coupled via power supply lines to a power supply device 12. The power supply device 12 may comprise a furnace transformer.

The electric arc furnace 1 also features three structure-borne sound sensors 4a, 4b, 4c, which may be arranged on furnace walls 2 capable of vibration. The structure-borne sound sensors 4a, 4b, 4c may be arranged on the furnace wall 2 or the furnace panel closest to an electrode 3a, 3b, 3c.

The electric arc furnace 1 further comprises a signal processing device 8, to which the signals of the electrode current detection devices 13a, 13b, 13c and the signals of the structure-borne sound sensors 4a, 4b, 4c are able to be supplied.

Stored on the signal processing device 8 is machine-readable program code 21. This machine-readable program code 21 has control commands which cause signal processing device 8 to carry out an embodiment of the method when these commands are executed.

The machine-readable program code 21 can be stored on the signal processing device 8 by means of a storage medium 22, e.g. by means of a USB stick, CD, DVD or other data carrier. It can also be stored permanently on the signal processing device 8. The program code 21 can also be provided via a network.

The signal processing device 8 is thus embodied such that a charging time can be determined.

The signal processing device 8 may be actively connected to an open-loop and/or closed-loop control device 9, so that, when the charging time is reached, a charging process can be initiated or carried out, e.g., fully automatically. To this end the open-loop and/or closed-loop control device 9 is actively connected to a charging device 10, e.g. a movable scrap basket.

The open-loop and/or closed-loop control device 9 can also be used for open-loop and/or closed-loop control of further functions of the electric arc furnace 1, for example for electrode regulation or similar. This is not shown in FIG. 1 for reasons of clarity.

If the charging time is determined without using structure-borne sound signals, especially just by means of the electrode currents, the installation of the structure-borne sound sensors 4a, 4b, 4c on the electric arc furnace 1 for the purposes of determining the charging time can also be dispensed with.

However the structure-borne sound sensors 4a, 4b, 4c can also be used advantageously for other purpose, cf. WO 2009095292 A1, WO 2007009924 A1 or WO 2009095396 A1 for example.

The structure-borne sound sensors 4a, 4b, 4c may be actively connected to a device 6 for amplifying and/or converting structure-borne sound signals from electric signals into optical signals. The optical signals are transmitted from the device 6 by means of an optical waveguide 7 to the signal processing device 8. Because of the harsh environmental conditions a translation of electrical signals into optical signals is practicable.

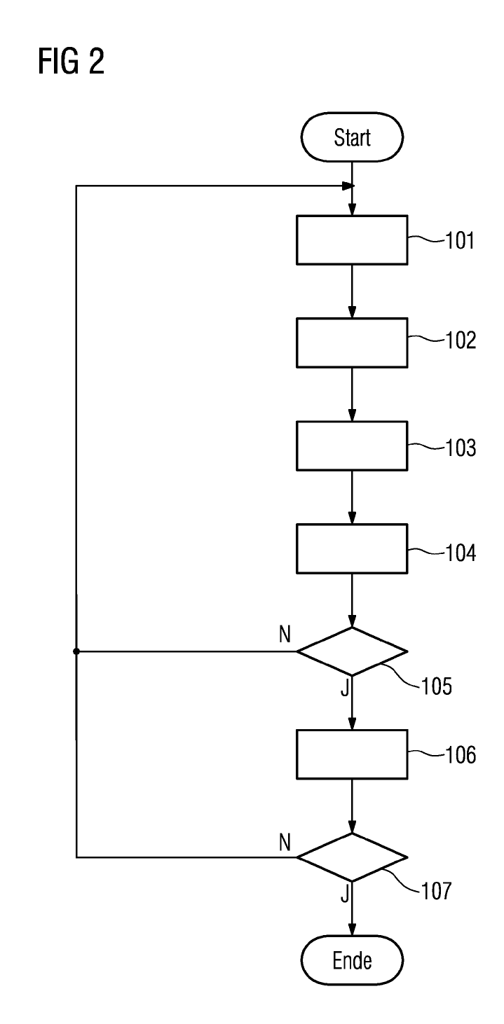

An explanation is given below with reference to FIG. 2 as to how a charging signal can be determined on the basis of electrode currents.

In the flow diagram the starting point employed is that the first filling of the electric arc furnace with scrap has taken place and the first charge is now being melted.

For this purpose, in a method step 101, the electrode currents of the respective electrode are captured. These are fed to the open-loop and/or closed-loop device and further processed there.

In a method step 102 the electrode currents are transformed from the time range into the frequency range, e.g. by means of Fast Fourier transformation, abbreviated to FFT hereafter. The use of FFT has proved to be practicable.

However other transformation algorithms can also be used by the person skilled in the art, which make it possible to convert the electrode current signal from a time range into a frequency range.

By means of the Fourier transformation the frequency-specific contributions or amounts for the electrode current can be determined. These amounts are summed for specific frequency ranges of the frequency-dependent currents for a respective frequency range and for the three electrodes.

Of the sum of the spectral components S1 of the square-wave current I between the harmonics at 100 Hz and 200 Hz, between 200 Hz and 300 Hz, between 300 Hz and 400 Hz or between 400 Hz and 500 Hz for the three electrodes k is calculated from

$$S 1 = {\sum }_{k = 1}^{3} ( {\sum }_{j = 1}^{4} ( {\sum }_{i = 100 j + x}^{100 ( j + 1 ) - x} \vert {FFT ( {I}_{k}^{2} )}_{i} \vert ) )$$

With index k for the electrodes, a distance value x, which typically amounts to 3 to 6 Hz in order to provide a sufficiently wide distance from the harmonic j and |FFT(Iₖ²)| for the amount of the Fourier transformation at i Hz of the corresponding square-wave electrode current signal Iₖ² of the electrode k.

This corresponds to the current component which will contribute to the electrode current signal apart from the basic harmonics and the harmonic oscillations.

Furthermore the spectral component S2 is determined for the harmonics of the doubled mains operating frequency of the furnace which is supplied by current components at and in the immediate vicinity of 200 Hz, 300 Hz, 400 Hz and 500 Hz. This is done in accordance with:

$$S 2 = {\sum }_{k = 1}^{3} ( {\sum }_{i = 2}^{5} \vert {FFT ( {I}_{k}^{2} )}_{100 i} \vert )$$

This method of operation is based on the observation that the anharmonicity of the electrode current at the transition from burning onto scrap, referred to as the scrap phase below, to burning onto liquid metal, referred to below as the liquid bath phase, decreases sharply. I.e. in the scrap phase, as well as the basic harmonics at 100 Hz (for a main operating frequency of 50 Hz) and their harmonic oscillations at 200 Hz, 300 Hz etc. spectral components can be seen to a significant extent between these harmonics. In the flat bath phase these components decrease sharply, so that practically only the first harmonics and their multiples are present. The measure S for the melting of the scrap in the area of the electrodes can thus advantageously be determined by means of this knowledge.

At another mains operating frequency, e.g. at 60 Hz, the basic harmonics would be 120 Hz and the harmonic oscillations would be a whole-number multiple thereof. This can be used in countries outside Europe, in the USA for example.

In a method step 103 a quotient is now formed from the signals determined. If for example the ratio S1/S2 is formed and this is multipled by a sensitivity factor a (depending on the electric arc furnace and its embodiment, amounting to ≈2) and if this value is limited to one, a measure y is obtained for further calculation

$$y = min ( 1 , a \cdot \frac{S 2}{S 1} ) .$$

In a method step 104 y is now used in a so-called S function, and such that the first signal S for the determination of the scrap melting is obtained:

$$S = y - ( \frac{1}{2 π} ) \cdot sin ( 2 π * y ) .$$

The first signal S is close to zero during the scrap phase and changes to a value approaching one in the liquid bath phase. This signal forms the first criterion for a charging signal to be output, since this reacts very sensitively to the melting behavior of the scrap in the area of the electrodes.

In a method step 105 a check is made as to whether the first signal S lies above a predetermined threshold value for a predetermined duration. 10 to 40 seconds, especially 20 seconds, can be selected as the predetermined duration within which the threshold value must be exceeded. The threshold value itself—if the first signal for complete melting lies at appr. 1—can be selected for example to range between 0.6 to 0.8, especially 0.7.

As soon as method step 105 results in the threshold value having been exceeded for at least 20 seconds, in a method step 106 a charging signal is output, i.e. that scrap can now be introduced once again into the electric arc furnace.

The output charging signal can both initiate a fully automatic charging of the electric arc furnace and can also inform operating personnel about the availability of an optimum charging time, for example via a visual indication and/or by means of acoustic means.

Where the result of the check is that the threshold value has not been exceeded for the predetermined minimum duration, the electrode currents continue to be analyzed in accordance with the method given above.

In a method step 107 a check is made as to whether the method is to continue to be executed, especially after charging the furnace with the next load of material to be melted. Especially with three charges required to reach the tap weight, it is for example no longer necessary to let the process continue to run after charging the furnace with the third load of scrap, since after the third charge has been loaded into the electric arc furnace no further charging takes place. Instead the next thing to occur—after a desired melt is present—is a tapping of the liquid metal. To this extent of further determination of a charging time may be superfluous.

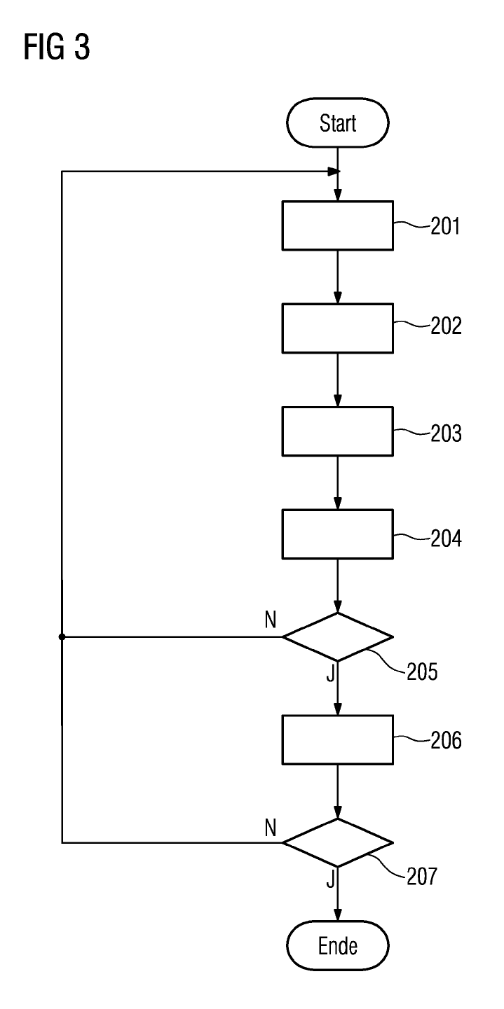

FIG. 3 shows an alternate embodiment for determining the charging time for an electric arc furnace. This method is based on the same starting conditions. The first filling of the electric arc furnace with scrap has been done and the furnace is in operation for the purposes of melting this scrap.

In a method step 201 structure-borne sound signals are captured with available structure-borne sound sensors. The signals captured by the structure-borne sound sensors are designated Ksₛ, with the index s being a count index and in the present example running from 1 to 3, since three structure-borne sound sensors are included in the electric arc furnace.

The use of the second signal on the basis of structure-borne sound signals is based on the observation that the structure-borne sound oscillations of the furnace delimitation, especially of the furnace panel, on transition into the flat bath phase, concentrate on harmonics, i.e. whole-number multiples of twice the mains frequency. At 50 Hz mains operating frequency the frequencies 100 Hz, 200 Hz, 300 Hz etc. essentially occur.

In the scrap melting phase the power in the frequency spectrum of the structure-borne sound is distributed comparatively evenly over a larger frequency range.

The second signal SKₛ, which is established for determining the charging time and can be associated with the melting of the scrap on the furnace walls, can thus be advantageously determined by means of a signal-to-noise ratio. This occurs in a method step 202.

For this purpose a calculation is first made of the noise level SNⱼ of the harmonics j of the doubled mains operating frequency, with for example j=1, 2, . . . 6, i.e. frequencies of 100 Hz, 200 Hz, . . . 600 Hz.

The signal-to-noise level SNⱼ for the jth harmonic oscillations of the doubled mains operating frequency is formed by the ratio of the amount of the structure-borne sound signal component of the jth harmonic oscillation to the signal amount of the structure-borne sound signal components in the noise environment of the jth harmonic oscillation.

The noise environment is advantageously computed from the spectral components between 15 Hz and 35 Hz below and above the corresponding jth harmonic oscillation. Each harmonic oscillation j is computed in accordance with

$${SN}_{j} = \frac{1}{3} {\sum }_{s = 1}^{3} ( \frac{\vert {FFT ( {Ks}_{s} )}_{100 j} \vert}{{\sum }_{i = 15}^{35} ( \vert {FFT ( {Ks}_{s} )}_{100 j - i} \vert + \vert {FFT ( {Ks}_{s} )}_{100 j + i} \vert )} )$$

wherein Ksₛ is the structure-borne sound signal of the sensors s in the time range, and |FFT(Ksₛ)₁₀₀ⱼ| is the signal amount of the structure-borne sound signal at the frequency 100*j Hz.

The sum in the nominator produces the signal amount which lies in the specified frequency spectrum, i.e. lies in the interval [100*jHz−35 Hz, 100*jHz−15 Hz] as well as in the interval [100*jHz+15 Hz, 100*jHz+35 Hz]. The selected values of 15 Hz and 35 Hz are typical and can be adapted in accordance with requirements to an individual electric arc furnace. Values of 10 Hz and 40 Hz or 10 Hz and 30 Hz instead of the 15 Hz and 35 Hz selected above are especially conceivable.

This thus produces the individual noise levels for the respective jth harmonic oscillation. These individual noise levels are now summed to form a signal-to-noise ratio SNR, wherein the weighting vector \vec{g} is selectable. The ratio is thus calculated in accordance with

$$SNR = {\sum }_{j = 1}^{6} {g}_{j} \cdot {SN}_{j} .$$

It is shown to be advantageous for the weighting vector to be selected as follows: \vec{g}=(0, ⅓, ⅓, ⅓, 0, 0). With this type of weighting an average value of the signal to noise ratio for harmonic oscillations is formed for j=2, 3, 4, i.e. at 200 Hz, 300 Hz and 400 Hz.

On the basis of this signal plan an optimum possible charging time can already be well determined.

The accuracy of determining the charging time can however be increased further by the additional inclusion of an electrode current signal for determining the charging time. This method of operation is explained in the exemplary embodiment. However, as already mentioned above, it is not absolutely necessary to proceed in this way.

Thus in an alternative variant to the exemplary embodiment in accordance with FIG. 3 the method steps 203 and 204 can also be omitted.

Because of the improvement in the determination of the charging time however the inclusion of an electrode current component will be explained below. This occurs in the method steps 203 and 204.

In method step 203 a basic oscillation component, also referred to as basic oscillation content below, of the electrode current is now also taken into account for determining the second signal. The basic oscillation component or content is that component of the electrode current which is contributed by the network operating frequency to the overall signal. The inclusion of this basic signal component or content leads to greater process security, in that this represents a test criterion for evaluating the structure-borne sound.

Extreme operating conditions with an influence on the measured structure-borne sound could result in a few exceptional cases to an incorrect determination of the charging time. This can be avoided by including the basic oscillation component or content of the electrode current. Thus for example the charging is only initiated when the basic oscillation component of the electrode currents of all electrodes lies above a predetermined threshold value, around 0.9.

To determine the basic oscillation component of the electric currents, it is computed in the present example of the 50 Hz component of the electrical current I for each electrode k using the Fourier transformation of the currents and the effective value I_{eff,k} is determined:

$$GG = \frac{1}{3} {\sum }_{k = 1}^{3} \frac{\vert {FFT ( {I}_{k} )}_{50} \vert}{{I}_{eff , k}}$$

In the present example k runs from 1 to 3, since the electric arc furnace has three electrodes. GG designates the basic oscillation component or content. |FFT(Iₖ)₅₀| is the amount of the signal contribution of the electrode current at 50 Hz. FFT once again stands for Fast Fourier Transformation here, which can be used as a means for determining the basic oscillation component or content.

In a method step 204 the second signal SKs is now determined from a combination of the determined signal-to-noise ratio SNR and the basic oscillation content of the second signal SKs which is included for determining the charging time.

This is done by including the determined signal-to-noise ratio and the basic oscillation content in the following equation:

SKs=a·(SNR−b)·(GG−0.9)

The factor a may be determined so that the second signal SKs approaches 1 when the flat bath phase is reached in the electric arc furnace. The parameter b is an offset value which is to be established individually for the respective electric arc furnace.

The second signal SKs is close to zero in the scrap phase and increases sharply in the liquid bath phase. This means that it is possible to also include this signal in order to determine the optimum possible charging time.

Similarly to the exemplary embodiment in accordance with FIG. 2 a check is made in a method step 205 as to whether the second signal exceeds a pre-determined threshold value for a predetermined minimum duration. In respect of the threshold value and determining the duration, the information relating to FIG. 2 and in the same way to FIG. 3 applies.

If the threshold value for a predetermined minimum duration is exceeded by the second signal, in a method step 206 a charging signal is output. In this case the information given as part of the explanations for method step 106 from FIG. 2 applies.

The check in respect of the ending of the method in a method step 207 likewise occurs in a similar manner to method step 107 of FIG. 2.

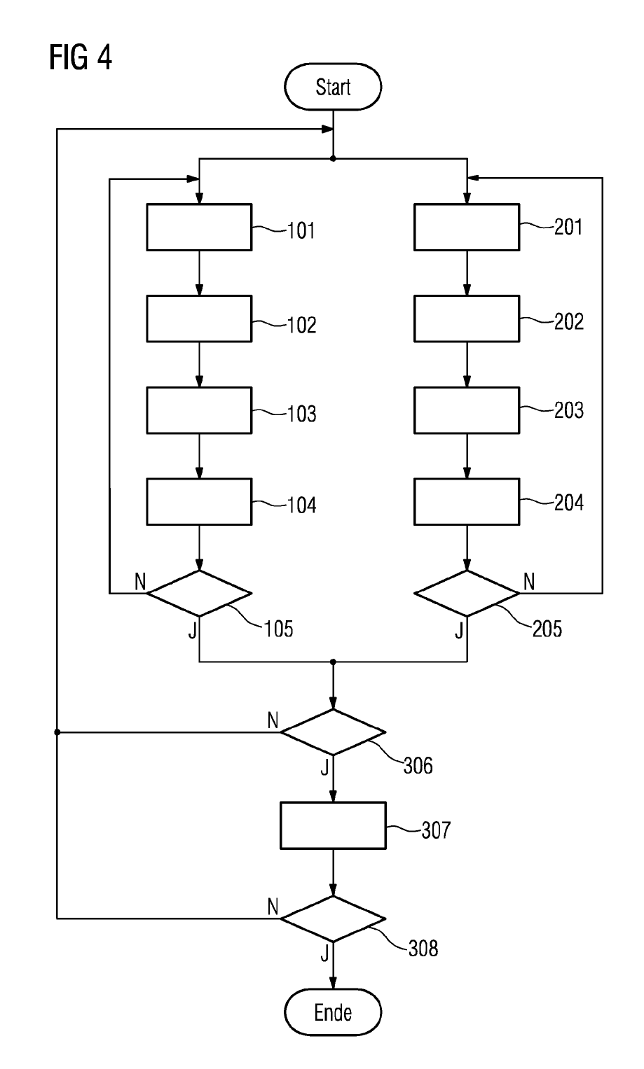

FIG. 4 shows a combination of the exemplary embodiment for FIG. 2 and for FIG. 3.

Here the first signal in accordance with FIG. 2 and second signal in accordance with FIG. 3 are established. For establishing the signals the reader is thus referred to the information given in relation to FIG. 2 and FIG. 3.

In a method step 306 May check is made in accordance with FIG. 3 as to whether the first signal and also the second signal is greater in each case for a pre-determined minimum duration than the respective threshold value. If this is not the case neither of the two signals or only one of the two signals is greater for the prescribed minimum duration than the respective threshold value, no charging signal is output.

As an alternative an average value from the first and the second signal can also be formed and this can be subjected to a check in respect of the threshold value and the duration for which the threshold value is exceeded.

However—depending on embodiment—as soon as the corresponding average signal or the first and the second signal fulfill the test criterion a charging signal is output in method step 307.

The charging signal can be output by the corresponding actuators which are required for charging the furnace with scrap being activated by an open-loop or closed-loop control device directly after the charging signal is available. As an alternative, by notifying the availability of an optimum charging time to operating personnel, charging by the operating personnel can be initiated.

Subsequently, in a method step 308, an interrogation is carried out as to whether the method is to be ended. The corresponding information for FIG. 2 also applies in this case.

What is claimed is:

1. A method for determining a charging time for charging an electric arc furnace with material to be melted, wherein the electric arc furnace has at least one electrode for heating material to be melted within the electric arc furnace by means of an electric arc, the method comprising:
determining a signal for defining a phase state of an electric arc root on a side of the material to be melted based on a detected electrode current,
checking whether a signal exceeds a predetermined threshold value for a predetermined minimum duration, and
determining the charging time based on a time when the signal exceeds the threshold value for the predetermined minimum duration.

2. The method as claimed in claim 1, wherein an S function is used to establish the signal.

3. The method of claim 2, wherein the signal for the S function is determined based on a ratio of electrode current contributions for a whole-number multiple of double the mains operating frequency and electrode current contributions is included, which are present between whole-number multiples of double the mains operating frequency.

4. A method for determining a charging time for charging an electric arc furnace with material to be melted, wherein the electric arc furnace has at least one electrode for heating material to be melted within the electric arc furnace by means of an electric arc, the method comprising:
determining based on detected structure-borne sound waves a signal for defining a part of the solid-type material to be melted adhering to a delimitation of the electric arc furnace,
checking whether the signal exceeds a predetermined threshold value for a predetermined minimum duration, and
determining the charging time based on a time when the signal exceeds the threshold value for the predetermined minimum duration.

5. The method of claim 4, wherein the second signal is determined based on a signal-to-noise ratio from structure-borne sound signal components of discrete frequencies and from structure-borne sound signal components for frequencies deviating in a predetermined interval from discrete frequencies.

6. The method of claim 4, the second signal is determined based on an electrode current signal component at a mains operating frequency of the electric arc furnace.

7. The method of claim 6, wherein the second signal is determined based on the equation:
SKs=c*(SNR−d)*(GG−0.9),
wherein
SNR: is the signal-to-noise ratio,
GG: is the electrode current component at the mains operating frequency
c: is a gain factor and
d: is an offset value.

8. A method for determining a charging time for charging an electric arc furnace with material to be melted, wherein the electric arc furnace has at least one electrode for heating material to be melted within the electric arc furnace by means of an electric arc, the method comprising:
determining a first signal for defining a phase state of an electric arc root based on a detected electrode current,
determining based on detected structure-borne sound waves a second signal for determining a solid-type part of the material to be melted adhering to a delimitation of the electric arc furnace,
determining the charging time based on the first signal and the second signal.

9. The method of claim 8, comprising:
determining an average from the first signal and the second signal,
checking whether the average signal exceeds a predetermined threshold value for a predetermined minimum duration, and
determining the charging time based on a time when the average signal lies above the threshold value for a predetermined minimum duration.

10. The method of claim 8, comprising:
checking whether the first signal exceeds a first predetermined threshold value for a first predetermined minimum duration,
checking whether the second signal exceeds a second predetermined threshold value for a second predetermined minimum duration, and
determining the charging time based on a time when the first and the second signal simultaneously each lie above the respective associated threshold values for the respective predetermined minimum durations.

11. The method of claim 8,
wherein the electric arc furnace comprises multiple electrodes, and
wherein the determination of the charging time is based on detected electrode currents of from each of the multiple electrodes.

12-14. (canceled)

15. An electric arc furnace comprising:
at least one electrode,
an electrode current detection device- configured to detect an electrode current of the at least one electrode,
at least one structure-borne sound sensor configured to detective structure-borne sound vibrations of a delimitation of the electric arc furnace, and
a signal processing device configured to
determine based on the detected electrode current of the at least one electrode a first signal for defining a phase state of an electric arc root,
determine based on detected structure-borne sound vibrations a second signal for determining a solid-type part of the material to be melted adhering to a delimitation of the electric arc furnace, and
determine the charging time based on the first signal and the second signal,
wherein the electrode current detection device and the structure-borne sound sensors are actively connected to the signal processing device.

16. The electric arc furnace of claim 15, wherein the signal processing device is actively connected to an open-loop and/or closed-loop control device that is actively connected to a charging device, and wherein the charging of material to be melted is able to be controlled and/or regulated by the open-loop and/or closed-loop control device.

17. The method of claim 1, wherein the charging time is reached at the earliest when the signal exceeds the threshold value for the predetermined minimum duration.

18. The method of claim 4, wherein the charging time is reached at the earliest when the signal exceeds the threshold value for the predetermined minimum duration.

19. The method of claim 9, wherein the charging time is reached at the earliest when the average signal exceeds the threshold value for the predetermined minimum duration.

20. The method of claim 8,
wherein the electric arc furnace comprises multiple structure-borne sound sensors, and
wherein the determination of the charging time is based on detected structure-borne sound vibrations from each of the multiple structure-borne sound sensors.
